(19) United States
(12) Patent Application Publication
(10) Pub. No.: US 2014/0045979 A1
(43) Pub. Date: Feb. 13, 2014

(54) POLY(PHENYLENE ETHER) COMPOSITION AND INJECTION MOLDED ARTICLE THEREOF

(71) Applicants: Christopher Ziegler, Rensselaer, NY (US); Christian Lietzau, Delmar, NY (US)

(72) Inventors: Christopher Ziegler, Rensselaer, NY (US); Christian Lietzau, Delmar, NY (US)

(73) Assignee: SABIC Innovative Plastics IP B.V., Bergen op Zoom (NL)

(21) Appl. No.: 13/570,301

(22) Filed: Aug. 9, 2012

(51) Int. Cl. C08L 71/12; C08K 5/18; C08K 3/22; C08K 5/13; C08K 5/523; C08K 3/32

(52) U.S. Cl. 524/127

(57) ABSTRACT

A composition having a combination of high heat resistance, high impact strength, and high flame retardance includes specific amounts of poly(phenylene ether), hydrogenated block copolymer, and organophosphate flame retardant. The composition has minimal amounts or excludes certain styrenic polymers, polyolefins, and reinforcing fillers. Also disclosed are injection molded articles formed from the composition. The composition is particularly useful as a molding composition for photovoltaic junction boxes and connectors.

### BACKGROUND OF THE INVENTION

Photovoltaic junction boxes are generally rectangular, low profile plastic housings which protect electrical connections against the rigorous challenges of the outdoor environment at various points within a photovoltaic installation, from individual solar energy collection panels to power collection circuits and power management equipment for delivery to a local electrical load circuit or outgoing power transmission lines. These junction boxes can contain a varying number of wiring compartments and can be provided with wiring terminals, connectors, or leads to accommodate current-carrying conductors in a secure manner to assure that reliable reproducible connections can readily be accomplished in the field.

Photovoltaic junction boxes must therefore be manufactured to exacting tolerances to provide a durable weather-resistant housing for electrical connections that maintains its protective integrity while withstanding challenges such as impacts from objects, wind-driven rain, and exposure to extreme heat, damaging ultraviolet radiation, and fire. Therefore, polymeric materials used for the manufacture of photovoltaic junction boxes must simultaneously meet several property requirements relating to moldability, flame retardancy, heat resistance, and ductility. In addition, the polymeric materials must have good oxidation resistance to retain useful properties for an extended period of time in outdoor use.

Some poly(phenylene ether)-based molding compositions are currently used for photovoltaic junction boxes and connectors, in particular, poly(phenylene ether)/polystyrene blends (PPE/PS). However next generation photovoltaic junction boxes and connectors must have high heat resistance, high impact strength, and high flame retardance. Although known PPE/PS compositions can meet any one or two of these critical-to-performance properties, none can meet all three. Thus there is a need for poly(phenylene ether)-based molding compositions having a combination of high heat resistance, high impact strength, and high flame retardance. Moreover, these properties should preferably be achieved without using halogenated flame retardants, the use of which is prohibited in many jurisdictions.

### BRIEF SUMMARY OF EMBODIMENTS OF THE INVENTION

The need for a poly(phenylene ether)-based molding composition having a combination of high heat resistance, high impact strength, and high flame retardance, is met by a composition comprising: 68 to 84 weight percent of a poly(phenylene ether); 6 to 16 weight percent of a hydrogenated block copolymer of an alkenyl aromatic compound and a conjugated diene, wherein the hydrogenated block copolymer comprises 10 to 45 weight percent poly(alkenyl aromatic) content, based on the weight of the hydrogenated block copolymer; 10 to 16 weight percent of a flame retardant consisting of an organophosphate ester; less than or equal to 2 weight percent combined of homopolystyrenes, rubber-modified impact polystyrenes, and unhydrogenated block copolymers of an alkenyl aromatic compound and a conjugated diene, based on the total weight of the composition; less than or equal to 4 weight percent polyolefin, based on the total weight of the composition; and less than or equal to 5 weight percent of a reinforcing filler having an average aspect ratio of greater than 3, based on the total weight of the composition; wherein the weight percents of the poly(phenylene ether), the hydrogenated block copolymer, and the flame retardant are based on the combined weight of the poly(phenylene ether), the hydrogenated block copolymer and the flame retardant.

Another embodiment is an injection molded article, comprising a composition comprising: 68 to 84 weight percent of a poly(phenylene ether); 6 to 16 weight percent of a hydrogenated block copolymer of an alkenyl aromatic compound and a conjugated diene, wherein the hydrogenated block copolymer comprises 10 to 45 weight percent poly(alkenyl aromatic) content, based on the weight of the hydrogenated block copolymer; and 10 to 16 weight percent of a flame retardant consisting of an organophosphate ester; less than or equal to 2 weight percent combined of homopolystyrenes, rubber-modified impact polystyrenes, and unhydrogenated block copolymers of an alkenyl aromatic compound and a conjugated diene, based on the total weight of the composition; less than or equal to 4 weight percent polyolefin, based on the total weight of the composition; and less than or equal to 5 weight percent of a reinforcing filler having an average aspect ratio of greater than 3, based on the total weight of the composition; wherein the weight percents of the poly(phenylene ether), the hydrogenated block copolymer, and the flame retardant are based on the combined weight of the poly(phenylene ether), the hydrogenated block copolymer and the flame retardant.

These and other embodiments are discussed in detail below.

### DETAILED DESCRIPTION OF THE INVENTION

Impact strength, heat distortion temperature, and flame retardance are needed for demanding applications, such as photovoltaic junction boxes and connectors. Known poly(phenylene ether)/polystyrene compositions can have any one of these properties, or any two of these properties, for example high heat distortion temperature and high flame retardance or high impact strength and high flame retardance. However, known PPE/PS compositions do not have all three of these properties. The present inventors have discovered a poly(phenylene ether) composition having a combination of high heat resistance, high impact strength, and high flame retardance. Moreover, these properties can be achieved without using halogenated flame retardants, the use of which is prohibited in many jurisdictions.

The composition comprises 68 to 84 weight percent of a poly(phenylene ether); 6 to 16 weight percent of a hydrogenated block copolymer of an alkenyl aromatic compound and a conjugated diene, wherein the hydrogenated block copolymer comprises 10 to 45 weight percent poly(alkenyl aromatic) content, based on the weight of the hydrogenated block copolymer; 10 to 16 weight percent of a flame retardant consisting of an organophosphate ester; less than or equal to 2 weight percent combined of homopolystyrenes, rubber-modified impact polystyrenes, and unhydrogenated block copolymers of an alkenyl aromatic compound and a conjugated diene, based on the total weight of the composition; less than or equal to 4 weight percent polyolefin, based on the total weight of the composition; and less than or equal to 5 weight percent of a reinforcing filler having an average aspect ratio of greater than 3, based on the total weight of the composition; wherein the weight percents of the poly(phenylene ether), the hydrogenated block copolymer, and the flame retardant are based on the combined weight of the poly(phenylene ether), the hydrogenated block copolymer and the flame retardant.

The composition comprises a poly(phenylene ether). Suitable poly(phenylene ether)s include those comprising repeating structural units having the formula

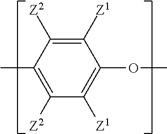

wherein each occurrence of Z¹ is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each occurrence of Z² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms. As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. As one example, Z¹ can be a di-n-butylaminomethyl group formed by reaction of a terminal 3,5-dimethyl-1,4-phenyl group with the di-n-butylamine component of an oxidative polymerization catalyst.

The poly(phenylene ether) can have an intrinsic viscosity of 0.35 to 0.6 deciliter per gram measured at 25° C. in chloroform. Within this range, the poly(phenylene ether) intrinsic viscosity can be 0.35 to 0.5 deciliter per gram, more specifically 0.4 to 0.5 deciliter per gram.

The poly(phenylene ether) has a weight average molecular weight of at least 70,000 atomic mass units after being compounded with the other components of the composition. In some embodiments, the poly(phenylene ether) after being compounded with the other components has a weight average molecular weight of 70,000 to 110,000 atomic mass units, specifically 70,000 to 100,000 atomic mass units, more specifically 70,000 to 90,000 atomic mass units. Weight average molecular weight can be determined by gel permeation chromatography and based on comparison to polystyrene standards.

In some embodiments, the poly(phenylene ether) before being compounded with the other components, has a weight average molecular weight of 60,000 to 90,000 atomic mass units, specifically 60,000 to 80,000 atomic mass units, more specifically 60,000 to 70,000 atomic mass units. These pre-compounding molecular weights can provide the desired post-compounding molecular weights described above.

In some embodiments, the poly(phenylene ether) is essentially free of incorporated diphenoquinone residues. In the context, “essentially free” means that the less than 1 weight percent of poly(phenylene ether) molecules comprise the residue of a diphenoquinone. As described in U.S. Pat. No. 3,306,874 to Hay, synthesis of poly(phenylene ether) by oxidative polymerization of monohydric phenol yields not only the desired poly(phenylene ether) but also a diphenoquinone as side product. For example, when the monohydric phenol is 2,6-dimethylphenol, 3,3′,5,5′-tetramethyldiphenoquinone is generated. Typically, the diphenoquinone is “reequilibrated” into the poly(phenylene ether) (i.e., the diphenoquinone is incorporated into the poly(phenylene ether) structure) by heating the polymerization reaction mixture to yield a poly(phenylene ether) comprising terminal or internal diphenoquinone residues. For example, when a poly(phenylene ether) is prepared by oxidative polymerization of 2,6-dimethylphenol to yield poly(2,6-dimethyl-1,4-phenylene ether) and 3,3′,5,5′-tetramethyldiphenoquinone, reequilibration of the reaction mixture can produce a poly(phenylene ether) with terminal and internal residues of incorporated diphenoquinone. However, such reequilibration reduces the molecular weight of the poly(phenylene ether). Accordingly, when a higher molecular weight poly(phenylene ether) is desired, it may be desirable to separate the diphenoquinone from the poly(phenylene ether) rather than reequilibrating the diphenoquinone into the poly(phenylene ether) chains. Such a separation can be achieved, for example, by precipitation of the poly(phenylene ether) in a solvent or solvent mixture in which the poly(phenylene ether) is insoluble and the diphenoquinone is soluble. For example, when a poly(phenylene ether) is prepared by oxidative polymerization of 2,6-dimethylphenol in toluene to yield a toluene solution comprising poly(2,6-dimethyl-1,4-phenylene ether) and 3,3′,5,5′-tetramethyldiphenoquinone, a poly(2,6-dimethyl-1,4-phenylene ether) essentially free of diphenoquinone can be obtained by mixing 1 volume of the toluene solution with 1 to 4 volumes of methanol or a methanol/water mixture. Alternatively, the amount of diphenoquinone side-product generated during oxidative polymerization can be minimized (e.g., by initiating oxidative polymerization in the presence of less than 10 weight percent of the monohydric phenol and adding at least 95 weight percent of the monohydric phenol over the course of at least 50 minutes), and/or the reequilibration of the diphenoquinone into the poly(phenylene ether) chain can be minimized (e.g., by isolating the poly(phenylene ether) no more than 200 minutes after termination of oxidative polymerization). These approaches are described in U.S. Pat. No. 8,025,158 of Delsman et al. In an alternative approach utilizing the temperature-dependent solubility of diphenoquinone in toluene, a toluene solution containing diphenoquinone and poly(phenylene ether) can be adjusted to a temperature of 25° C., at which diphenoquinone is poorly soluble but the poly(phenylene ether) is soluble, and the insoluble diphenoquinone can be removed by solid-liquid separation (e.g., filtration).

The poly(phenylene ether) can comprise 2,6-dimethyl-1,4-phenylene ether units, 2,3,6-trimethyl-1,4-phenylene ether units, or a combination thereof. The poly(phenylene ether) can be a poly(2,6-dimethyl-1,4-phenylene ether). In some embodiments, the poly(phenylene ether) comprises a poly(2,6-dimethyl-1,4-phenylene ether) having an intrinsic viscosity of 0.35 to 0.6 deciliter per gram measured at 25° C. in chloroform. Within this range, the poly(2,6 dimethyl-1,4-phenylene ether) intrinsic viscosity can be 0.35 to 0.5 deciliter per gram, more specifically 0.4 to 0.5 deciliter per gram, as measured at 25° C. in chloroform.

In some embodiments, the poly(phenylene ether) comprises molecules having aminoalkyl-containing end group(s), typically located in a position ortho to the hydroxy group. The aminoalkyl-containing end group can be, for example, a di-n-butylaminomethyl group or a morpholinomethyl group. Also frequently present are tetramethyldiphenoquinone (TMDQ) end groups, typically obtained from 2,6-dimethylphenol-containing reaction mixtures in which tetramethyldiphenoquinone by-product is present. The poly(phenylene ether) can be in the form of a homopolymer, a copolymer, a graft copolymer, an ionomer, or a block copolymer, as well as combinations comprising at least one of the foregoing.

The composition comprises the poly(phenylene ether) in an amount of 68 to 84 weight percent, specifically 70 to 82 weight percent, more specifically 72 to 79 weight percent, based on the combined weight of the poly(phenylene ether), the hydrogenated block copolymer and the flame retardant.

The composition comprises a hydrogenated block copolymer of an alkenyl aromatic compound and a conjugated diene. For brevity, this component is referred to as the “hydrogenated block copolymer”. The hydrogenated block copolymer generally comprises 10 to 45 weight percent poly(alkenyl aromatic) content, based on the weight of the hydrogenated block copolymer. Within this range, the poly(alkenyl aromatic) content can be 20 to 40 weight percent, specifically 25 to 35 weight percent.

In some embodiments, the hydrogenated block copolymer has a weight average molecular weight of at least 100,000 atomic mass units. In some embodiments the hydrogenated block copolymer comprises a polystyrene-poly(ethylene-butylene)-polystyrene triblock copolymer having a weight average molecular weight of 100,000 to 1,000,000 atomic mass units, specifically 100,000 to 400,000 atomic mass units.

The alkenyl aromatic monomer used to prepare the hydrogenated block copolymer can have the structure

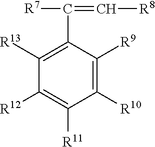

wherein R⁷ and R⁸ each independently represent a hydrogen atom, a C₁-C₈ alkyl group, or a C₂-C₈ alkenyl group; R⁹ and R¹³ each independently represent a hydrogen atom, a C₁-C₈ alkyl group, a chlorine atom, or a bromine atom; and R¹⁰, R¹¹ and R¹² each independently represent a hydrogen atom, a C₁-C₈ alkyl group, or a C₂-C₈ alkenyl group, or R¹⁰ and R¹¹ are taken together with the central aromatic ring to form a naphthyl group, or R¹¹ and R¹² are taken together with the central aromatic ring to form a naphthyl group. Specific alkenyl aromatic monomers include, for example, styrene, chlorostyrenes such as p-chlorostyrene, methylstyrenes such as alpha-methylstyrene and p-methylstyrene, and t-butylstyrenes such as 34-butylstyrene and 4-t-butylstyrene. In some embodiments, the alkenyl aromatic monomer is styrene.

The conjugated diene used to prepare the hydrogenated block copolymer can be a C₄-C₂₀ conjugated diene. Suitable conjugated dienes include, for example, 1,3-butadiene, 2-methyl-1,3-butadiene, 2-chloro-1,3-butadiene, 2,3-dimethyl-1,3-butadiene, 1,3-pentadiene, 1,3-hexadiene, and the like, and combinations thereof. In some embodiments, the conjugated diene is 1,3-butadiene, 2-methyl-1,3-butadiene, or a combination thereof. In some embodiments, the conjugated diene consists of 1,3-butadiene.

The hydrogenated block copolymer is a copolymer comprising (A) at least one block derived from an alkenyl aromatic compound and (B) at least one block derived from a conjugated diene, in which the aliphatic unsaturated group content in the block (B) is at least partially reduced by hydrogenation. In some embodiments, the aliphatic unsaturation in the (B) block is reduced by at least 50 percent, specifically at least 70 percent. The arrangement of blocks (A) and (B) includes a linear structure, a grafted structure, and a radial teleblock structure with or without a branched chain. Linear block copolymers include tapered linear structures and non-tapered linear structures. In some embodiments, the hydrogenated block copolymer has a tapered linear structure. In some embodiments, the hydrogenated block copolymer has a non-tapered linear structure. In some embodiments, the hydrogenated block copolymer comprises a (B) block that comprises random incorporation of alkenyl aromatic monomer. Linear block copolymer structures include diblock (A-B block), triblock (A-B-A block or B-A-B block), tetrablock (A-B-A-B block), and pentablock (A-B-A-B-A block or B-A-B-A-B block) structures as well as linear structures containing 6 or more blocks in total of (A) and (B), wherein the molecular weight of each (A) block can be the same as or different from that of other (A) blocks, and the molecular weight of each (B) block can be the same as or different from that of other (B) blocks. In some embodiments, the hydrogenated block copolymer is a diblock copolymer, a triblock copolymer, or a combination thereof.

In some embodiments, the hydrogenated block copolymer excludes the residue of monomers other than the alkenyl aromatic compound and the conjugated diene. In some embodiments, the hydrogenated block copolymer consists of blocks derived from the alkenyl aromatic compound and the conjugated diene. It does not comprise grafts formed from these or any other monomers. It also consists of carbon and hydrogen atoms and therefore excludes heteroatoms. In some embodiments, the hydrogenated block copolymer includes the residue of one or more acid functionalizing agents, such as maleic anhydride. In some embodiments, the hydrogenated block copolymer comprises a polystyrene-poly(ethylene-butylene)-polystyrene triblock copolymer.

Methods for preparing hydrogenated block copolymers are known in the art and many hydrogenated block copolymers are commercially available. Illustrative commercially available hydrogenated block copolymers include the polystyrene-poly(ethylene-propylene) diblock copolymers available from Kraton Polymers as KRATON G1701 (having 37 weight percent polystyrene) and G1702 (having 28 weight percent polystyrene); the polystyrene-poly(ethylene-butylene)-polystyrene triblock copolymers available from Kraton Polymers as KRATON G1641 (having 33 weight percent polystyrene), G1651 (having 31-33 weight percent polystyrene), and G1654 (having 31 weight percent polystyrene); and the polystyrene-poly(ethylene-ethylene/propylene)-polystyrene triblock copolymers available from Kuraray as SEPTON S4044, S4055, S4077, and S4099. Additional commercially available hydrogenated block copolymers include polystyrene-poly(ethylene-butylene)-polystyrene (SEBS) triblock copolymers available from Dynasol as CALPRENE CH-6170, CH-7171, CH-6174 and CH-6140, and from Kuraray as SEPTON 8006 and 8007; polystyrene-poly(ethylene-propylene)-polystyrene (SEPS) copolymers available from Kuraray as SEPTON 2006 and 2007; and oil-extended compounds of these hydrogenated block copolymers available from Kraton Polymers as KRATON G4609 and G4610 and from Asahi as TUFTEC H1272. Mixtures of two of more hydrogenated block copolymers can be used. In some embodiments, the hydrogenated block copolymer comprises a polystyrene poly(ethylene-butylene)-polystyrene triblock copolymer having a weight average molecular weight of at least 100,000 atomic mass units.

The composition comprises the hydrogenated block copolymer in an amount of 6 to 16 weight percent, specifically 7 to 15 weight percent, more specifically 9 to 13 weight percent, based on the combined weight of the poly(phenylene ether), the hydrogenated block copolymer and the flame retardant.

The composition comprises a flame retardant consisting of an organophosphate ester. A flame retardant is a chemical compound or mixture of chemical compounds capable of improving the flame retardancy of the composition. Exemplary organophosphate ester flame retardants include phosphate esters comprising phenyl groups, substituted phenyl groups, or a combination of phenyl groups and substituted phenyl groups, bis-aryl phosphate esters based upon resorcinol such as, for example, resorcinol bis(diphenyl phosphate), as well as those based upon bisphenols such as, for example, bisphenol A bis(diphenyl phosphate). In some embodiments the organophosphate ester has the formula

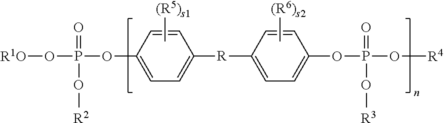

wherein R is independently at each occurrence a C₁-C₁₂ alkylene group; R⁵ and R⁶ are independently at each occurrence a C₁-C₅ alkyl group; R¹, R², and R⁴ are independently a C₁-C₁₂ hydrocarbyl group; R³ is independently at each occurrence a C₁-C₁₂ hydrocarbyl group; n is 1 to 25; and s1 and s2 are independently an integer equal to 0, 1, or 2. In some embodiments OR¹, OR², OR³ and OR⁴ are independently derived from phenol, a monoalkylphenol, a dialkylphenol, or a trialkylphenol. As readily appreciated by one of ordinary skill in the art, the bis-aryl phosphate is derived from a bisphenol. Exemplary bisphenols include 2,2-bis(4-hydroxyphenyl)propane (so-called bisphenol A), 2,2-bis(4-hydroxy-3-methylphenyl)propane, bis(4-hydroxyphenyl)methane, bis(4-hydroxy-3,5-dimethylphenyl)methane and 1,1-bis(4-hydroxyphenyl)ethane. In some embodiments, the bisphenol comprises bisphenol A.

In some embodiments, the organophosphate ester comprises an organophosphate ester having the formula

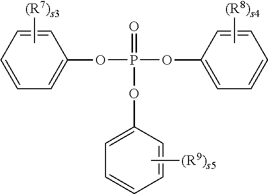

wherein R⁷, R⁸ and R⁹ are independently a C₁-C₁₂ hydrocarbyl group, and s3, s4 and s5 are independently an integer equal to 0, 1, 2, or 3.

In some embodiments, the organophosphate ester is selected from tris(alkylphenyl) phosphates (for example, CAS Reg. No. 89492-23-9 or CAS Reg. No. 78-33-1), resorcinol bis(diphenyl phosphate) (CAS Reg. No. 57583-54-7), bisphenol A bis(diphenyl phosphate) (CAS Reg. No. 181028-79-5), triphenyl phosphate (CAS Reg. No. 115-86-6), tris(isopropylphenyl) phosphates (for example, CAS Reg. No. 68937-41-7), and a mixture thereof. In some embodiments, the organophosphate ester is selected from the group consisting of bisphenol A bis(diphenyl phosphate), resorcinol bisphenol A bis(diphenyl phosphate), and a mixture thereof. In some embodiments, the organophosphate ester is bisphenol A bis(diphenyl phosphate).

The composition comprises the flame retardant in an amount of 10 to 16 weight percent, specifically 11 to 15 weight percent, more specifically 12 to 15 weight percent, based on the combined weight of the poly(phenylene ether), the hydrogenated block copolymer and the flame retardant.

In some embodiments, auxiliary flame retardants selected from the group consisting of nitrogen-containing flame retardants, metal hydroxides, and a mixture thereof, are minimized or excluded from the composition. The nitrogen-containing flame retardant comprises a nitrogen-containing heterocyclic base and a phosphate or pyrophosphate or polyphosphate acid. In some embodiments, the nitrogen-containing flame retardant has the formula

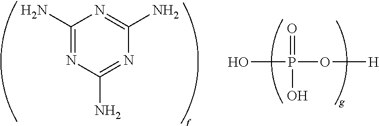

wherein g is 1 to 10,000, and the ratio of f to g is 0.5:1 to 1.7:1, specifically 0.7:1 to 1.3:1, more specifically 0.9:1 to 1.1:1. It will be understood that this formula includes species in which one or more protons are transferred from the phosphate group(s) to the melamine group(s). When g is 1, the nitrogen-containing flame retardant is melamine phosphate (CAS Reg. No. 20208-95-1). When g is 2, the nitrogen-containing flame retardant is melamine pyrophosphate (CAS Reg. No. 15541 60-3). When g is, on average, greater than 2, the nitrogen-containing flame retardant is a melamine polyphosphate (CAS Reg. No. 56386-64-2).

In some embodiments, the nitrogen-containing flame retardant is melamine pyrophosphate, melamine polyphosphate, or a mixture thereof. In some embodiments in which the nitrogen-containing flame retardant is melamine polyphosphate, g has an average value of greater than 2 to 10,000, specifically 5 to 1,000, more specifically 10 to 500. In some embodiments in which the nitrogen-containing flame retardant is melamine polyphosphate, g has an average value of greater than 2 to 500. Methods for preparing melamine phosphate, melamine pyrophosphate, and melamine polyphosphate are known in the art, and all are commercially available. For example, melamine polyphosphates may be prepared by reacting polyphosphoric acid and melamine, as described, for example, in U.S. Pat. No. 6,025,419 to Kasowski et al., or by heating melamine pyrophosphate under nitrogen at 290° C. to constant weight, as described in U.S. Pat. No. 5,998,503 to Jacobson et al. In some embodiments, the nitrogen-containing flame retardant comprises melamine cyanurate.

The nitrogen-containing flame retardant can have a low volatility. For example, in some embodiments, the nitrogen-containing flame retardant exhibits less than 1 percent weight loss by thermogravimetric analysis when heated at a rate of 20° C. per minute from 25 to 280° C., specifically 25 to 300° C., more specifically 25 to 320° C.

The metal hydroxide flame retardant can be, for example, aluminum oxide or magnesium oxide.

The composition can comprise less than or equal to 5 weight percent, specifically less than or equal to 3 weight percent, and more specifically less than or equal to 1 weight percent of an auxiliary flame retardant selected from the group consisting of nitrogen-containing flame retardants, metal hydroxides, and a mixture thereof, based on the total weight of the composition. In some embodiments, the composition excludes nitrogen-containing flame retardants, metal hydroxides, and a mixture thereof.

Homopolystyrenes, rubber-modified impact polystyrenes, and unhydrogenated block copolymers of an alkenyl aromatic compound and a conjugated diene are minimized or excluded from the composition. For example, the composition comprises less than or equal to 2 weight percent combined, of homopolystyrenes, rubber-modified impact polystyrenes, and unhydrogenated block copolymers of an alkenyl aromatic compound and a conjugated diene, based on the total weight of the composition. Within this range, the composition can comprise less than or equal to 1.5 weight percent, specifically less than or equal to 1 weight percent, and more specifically less than or equal to 0.5 weight percent combined, of homopolystyrenes, rubber-modified impact polystyrenes, and unhydrogenated block copolymers of an alkenyl aromatic compound and a conjugated diene, based on the total weight of the composition. In some embodiments, the composition excludes homopolystyrenes, rubber-modified impact polystyrenes, and unhydrogenated block copolymers of an alkenyl aromatic compound and a conjugated diene.

As used herein, the term “homopolystyrene” refers to a homopolymer of styrene. In some embodiments, the homopolystyrene has a number average molecular weight of 10,000 to 200,000 atomic mass units, specifically 30,000 to 100,000 atomic mass units. In a particular embodiment, the polystyrene is an atactic homopolystyrene having a number average molecular weight of 30,000 to 100,000 atomic mass units. The styrene homopolymer can be atactic, isotactic, or syndiotactic. In some embodiments, the homopolystyrene is an atactic polystyrene. The atactic homopolystyrene can have a melt flow index of 0.5 to 10 grams per 10 minutes, specifically 1 to 5 grams per 10 minutes, measured at 200° C. and 5 kilogram load according to ASTM D1238. The atactic homopolystyrene can have a mineral oil content of less than or equal to 5 weight percent, specifically less than or equal to 2 weight percent.

The rubber-modified polystyrene comprises polystyrene and polybutadiene. Rubber-modified polystyrenes are sometimes referred to as “high-impact polystyrenes” or “HIPS”. In some embodiments, the rubber-modified polystyrene comprises 80 to 96 weight percent polystyrene, specifically 88 to 94 weight percent polystyrene; and 4 to 20 weight percent polybutadiene, specifically 6 to 12 weight percent polybutadiene, based on the weight of the rubber-modified polystyrene. In some embodiments, the rubber-modified polystyrene has an effective gel content of 10 to 35 percent. An example of a rubber-modified polystyrene is GEH HIPS 1897, available from SABIC Innovative Plastics.

The unhydrogenated block copolymers are similar to the hydrogenated block copolymers described above, except that the aliphatic unsaturation of the poly(conjugated diene) blocks are not hydrogenated. Unhydrogenated block copolymers include, for example, polystyrene-polybutadiene diblock copolymers, polystyrene-polybutadiene-polystyrene triblock copolymers, polystyrene-polyisoprene diblock copolymers, polystyrene-polyisoprene-polystyrene triblock copolymers, and a mixture thereof. Unhydrogenated block copolymers are known in the art, and are described, for example, in Gerard Riess, G. Hurtrez, and P. Bahadur, Block Copolymers, 2 Encyclopedia of Polymer Science and Engineering, 324 (H. F. Mark et al. eds., 1985), incorporated herein by reference. They may be either pure block copolymers or tapered (overlap) copolymers. Tapered styrene-rubber block copolymers have an area of the polymer between the styrene and rubber blocks in which both monomer units are present. The taper area is thought to exhibit a gradient, from a styrene-rich area closest to the styrene block to a rubber-rich area closest to the rubber block.

Polyolefins are minimized or excluded from the composition. For example, the composition comprises less than or equal to 4 weight percent, specifically less than or equal to 3 weight percent, more specifically less than or equal to 2 weight percent, still more specifically less than or equal to 1 weight percent, and yet more specifically less than or equal to 0.5 weight percent of polyolefin, based on the total weight of the composition. In some embodiments, the composition excludes polyolefin.

Polyolefins include polyethylenes (including high density polyethylene (HDPE), low density polyethylene (LDPE), medium density polyethylene (MDPE), and linear low density polyethylene (LLDPE)), polypropylenes (including atactic, syndiotactic, and isotactic polypropylenes), and polyisobutylenes. Polyolefins and methods for their preparation are known in the art and are described for example in U.S. Pat. Nos. 2,933,480 to Gresham et al., 3,093,621 to Gladding, 3,211,709 to Adamek et al., 3,646,168 to Barrett, 3,790,519 to Wahlborg, 3,884,993 to Gros, 3,894,999 to Boozer et al., and 4,059,654 to von Bodungen. In some embodiments the polyolefin consists essentially of a polyolefin homopolymer, specifically a crystalline polyolefin homopolymer. The density of polyethylene (HDPE, LDPE, MDPE, LLDPE) can be 0.90 gram/cm³ to 0.98 gram/cm³. Polyolefins include ethylene/alpha-olefin copolymers, such as copolymers of ethylene and 1-butene, copolymers of ethylene and 1-hexene, and copolymers of ethylene and 1-octene. Additionally, copolymers of olefins can also be used, such as copolymers of polypropylene with rubber and polyethylene with rubber. Copolymers of polypropylene and rubber are sometimes referred to as impact modified polypropylene. Such copolymers are typically heterophasic and have sufficiently long sections of each component to have both amorphous and crystalline phases. In some embodiments the polyolefin comprises a polyolefin block copolymer comprising an end group consisting essentially of a polyolefin homopolymer of C₂ to C₃ olefins and a middle block comprising a copolymer of C₂ to C₁₂ olefins. Additionally the polyolefin can comprise a combination of homopolymer and copolymer, a combination of homopolymers having different melt temperatures, and/or a combination of homopolymers having a different melt flow rate. In some embodiments, the polyolefin comprises a high density polyethylene (HDPE). The high density polyethylene can have a density of 0.941 to 0.965 grams per milliliter. In some embodiments, the polyolefin has a melt flow rate (MFR) of 0.3 to 10 grams per ten minutes (g/10 min). Specifically, the melt flow rate can be 0.3 to 5 grams per ten minutes. Melt flow rate can be determined according to ASTM D1238-10 using either powdered or pelletized polyolefin, a load of 2.16 kilograms and a temperature suitable for the polyolefin (190° C. for ethylene-based polyolefins and 230° C. for propylene-based polyolefins). In some embodiments, the polyolefin comprises homopolyethylene or a polyethylene copolymer. Additionally the polyethylene can comprise a combination of homopolymer and copolymer, a combination of homopolymers having different melting temperatures, and/or a combination of homopolymers having different melt flow rates. The polyethylene can have a density of 0.911 to 0.98 grams per cubic centimeter. In some embodiments, the excluded polyolefin is LLDPE.

Reinforcing fillers are minimized or excluded from the composition. For example, in some embodiments, the composition comprises less than or equal to 5 weight percent reinforcing filler, based on the total weight of the composition. Within this range, the composition can comprise less than or equal to 1 weight percent, specifically less than or equal to 0.5 weight percent, more specifically less than or equal to 0.1 weight percent of reinforcing filler, based on the total weight of the composition. In some embodiments, the composition excludes reinforcing filler.

Reinforcing fillers can be in the shape of fibers, acicular crystals, whiskers, flakes, plates, or have irregular shapes. The average aspect ratio for fibrous, acicular, and whisker-shaped fillers is defined as length:diameter. The average aspect ratio of flaked and plate-like fillers is defined as average diameter of a circle of the same area:average thickness. The average aspect ratio can be greater than 1.5, specifically greater than 3.

The reinforcing filler can be in the shape of rigid fibers such as glass fibers, carbon fibers, metal fibers, ceramic fibers or whiskers, and the like. Glass fibers typically have a modulus of greater than or equal to 6,800 megapascals, and can be chopped or continuous. Glass fibers can have various cross-sections, for example, round, trapezoidal, rectangular, square, crescent, bilobal, trilobal, and hexagonal. Glass fibers can be in the form of chopped strands having an average length of from 0.1 mm to 10 mm, and having an average aspect ratio of 2 to 5. Glass fibers can be textile glass fibers such as E, A, C, ECR, R, S, D, and NE glasses and quartz, and the like.

In some applications, the surface of the fiber, in particular a glass fiber, is treated with a chemical coupling agent to improve adhesion to a thermoplastic resin in the composition. Examples of useful coupling agents are alkoxy silanes and alkoxy zirconates. Amino, epoxy, amide, or thio functional alkoxy silanes are especially useful. Fiber coatings with high thermal stability are preferred to prevent decomposition of the coating, which could result in foaming or gas generation during processing at the high melt temperatures required to injection mold the compositions.

Fibrous fillers include carbon fibers. Carbon fibers are generally classified according to their diameter, morphology, and degree of graphitization (morphology and degree of graphitization being interrelated). These characteristics are determined by the method used to synthesize the carbon fiber. For example, carbon fibers having diameters down to 5 micrometers, and graphene ribbons parallel to the fiber axis (in radial, planar, or circumferential arrangements) are produced commercially by pyrolysis of organic precursors in fibrous form, including phenolics, polyacrylonitrile (PAN), or pitch.

Fibrous fillers include short inorganic fibers such as those derived from blends comprising at least one of aluminum silicates, aluminum oxides, magnesium oxides, and calcium sulfate hemihydrate may also be added into the masterbatch. Other fibrous fillers include natural fillers, such as wood flour obtained by pulverizing wood, and fibrous products such as cellulose, cotton, sisal, jute, starch, cork flour, lignin, ground nut shells, corn, rice grain husks. Also included among fibrous fillers are single crystal fibers or whiskers, including silicon carbide, alumina, boron carbide, iron, nickel, and copper whiskers.

Fibrous fillers include organic polymer fibers. Illustrative examples of organic fibrous fillers include, for example, poly(ether ketone), polyimide, polybenzoxazole, poly(phenylene sulfide), polyesters, polyethylene, aromatic polyamides, aromatic polyimides or polyetherimides, polytetrafluoroethylene, acrylic resins, and poly(vinyl alcohol). Such reinforcing fillers may be provided in the form of monofilament or multifilament fibers and can be used either alone or in combination with other types of fiber, through, for example, co-weaving or core/sheath, side-by-side, orange-type or matrix and fibril constructions, or by other methods known to one skilled in the art of fiber manufacture. Typical cowoven structures include glass fiber-carbon fiber, carbon fiber-aromatic polyimide (aramid) fiber, and aromatic polyimide fiber-glass fiber. Fibrous fillers may be supplied in the form of, for example, rovings, woven fibrous reinforcements, such as 0-90 degree fabrics, non-woven fibrous reinforcements such as continuous strand mat, chopped strand mat, tissues, papers and felts and 3-dimensionally woven reinforcements, performs and braids.

The reinforcing filler can be in the shape of flakes or plates. Flaked or plate-like fillers include glass flakes, silicon carbide flakes, aluminum diboride flakes, aluminum flakes, steel flakes, mica, vermiculite, and the like.

In some embodiments, the composition can optionally further comprise a polytetrafluoroethylene. In some embodiments, the polytetrafluoroethylene (PTFE) is encapsulated in styrene-acrylonitrile copolymer (SAN) to form poly(styrene-acrylonitrile)-encapsulated PTFE. Poly(styrene-acrylonitrile)-encapsulated polytetrafluoroethylene can be made by polymerizing styrene and acrylonitrile in the presence of polytetrafluoroethylene. In some embodiments, the poly(styrene-acrylonitrile)-encapsulated polytetrafluoroethylene can comprise 30 to 70 weight percent polytetrafluoroethylene and 30 to 70 weight percent poly(styrene-acrylonitrile), based on the weight of the poly(styrene-acrylonitrile)-encapsulated polytetrafluoroethylene. In some embodiments, the encapsulating poly(styrene-acrylonitrile) comprises 50 to 90 weight percent styrene residues, and 10 to 50 weight percent acrylonitrile residues. When present in the composition, the poly(styrene-acrylonitrile)-encapsulated polytetrafluoroethylene can be present in an amount of 0.02 to 0.25 weight percent, specifically 0.04 to 0.2 weight percent, and more specifically 0.05 to 0.1 weight percent, based on the total weight of the composition.

The composition can optionally comprise tricalcium phosphate (Ca₅(OH)(PO₄)₃, CAS No. 1306-06-4). Tricalcium phosphate is also known as hydroxyapatite, hydroxylapatite, tribasic calcium phosphate, pentacalcium hydroxyorthophosphate and apatite. In some embodiments the tricalcium phosphate has an average particle size of 1 to 10 micrometers, specifically 2 to 8 micrometers. When present in the composition, the tricalcium phosphate can be present in an amount of 1 to 5 weight percent tricalcium phosphate, based on the total weight of the composition. Within this range, the amount of tricalcium phosphate can be 1.5 to 4 weight percent, specifically 2 to 3 weight percent, based on the total weight of the composition.

The composition can optionally comprise titanium dioxide (TiO₂). In some embodiments, the titanium dioxide has an average particle size of 0.1 to 0.5 micrometers, specifically 0.2 to 0.4 micrometers. When present in the composition, the titanium dioxide can be present in an amount of 0.5 to 5 weight percent, specifically 1 to 4 weight percent, based on the total weight of the composition.

The composition can optionally comprise an ester of salicylic acid or anthranilic acid. As used herein, the term “ester of salicylic acid” includes compounds and polymers in which the carboxy group of salicylic acid, the hydroxy group of salicylic acid, or both, have been esterified, and substituted derivatives thereof. Suitable esters of salicylic acid are described in U.S. Pat. No. 4,760,118 to White et al., and include phenyl salicylate, aspirin (acetyl salicylic acid), salicylic carbonate, polysalicylates including both linear polysalicylates and cyclic compounds such as disalicylide and trisalicylide. As used herein, the term “ester of anthranilic acid” includes compounds and polymers in which the carboxy group of anthranilic acid has been esterified, and substituted derivatives thereof. An example of an ester of anthranilic acid is isatoic anhydride. In some embodiments, the ester of salicylic acid is polysalicylate acetate. When present in the composition, the ester of salicylic acid can be present in an amount of 0.1 to 10 weight percent, specifically 0.5 to 5 weight percent, based on the total weight of the composition.

The composition can optionally comprise additives selected from the group consisting of fillers, stabilizers, antioxidants, mold release agents, processing aids, drip retardants, nucleating agents, UV blockers, dyes, pigments, fragrances, anti-static agents, mineral oil, metal deactivators, antiblocking agents, and combinations thereof. In some embodiments, the additives are selected from the group consisting of antioxidants, drip retardants, pigments, and a mixture thereof. When present in the composition, the additives can be present in a combined amount of 0.1 to 10 weight percent, specifically 0.2 to 5 weight percent, and more specifically 0.5 to 2 weight percent, based on the total weight of the composition.

The composition can, optionally, minimize or exclude poly(phenylene ether)-polysiloxane block copolymers. For example, in some embodiments, the composition comprises less than or equal to 5 weight percent poly(phenylene ether)-polysiloxane block copolymer, based on the total weight of the composition. Within this range, the composition can comprise less than or equal to 4 weight percent, specifically less than or equal to 3 weight percent, more specifically less than or equal to 2 weight percent, and still more specifically, less than or equal to 1 weight percent of poly(phenylene ether)-polysiloxane block copolymers, based on the total weight of the composition. In some embodiments, the composition excludes poly(phenylene ether)-polysiloxane block copolymers.

The poly(arylene ether)-polysiloxane block copolymer is synthesized by oxidative polymerization of a mixture of monohydric phenol and a hydroxyaryl-terminated polysiloxane. This oxidative polymerization produces poly(arylene ether)-polysiloxane block copolymer as the desired product and poly(arylene ether) homopolymer as a by-product. It is difficult and unnecessary to separate the poly(arylene ether) homopolymer from the poly(arylene ether)-polysiloxane block copolymer. The poly(arylene ether)-polysiloxane block copolymer can be incorporated into the injection molding compositions as a “poly(arylene ether)-polysiloxane block reaction product” that comprises both the poly(arylene ether) and the poly(arylene ether)-polysiloxane block copolymer.

The poly(arylene ether)-polysiloxane block copolymer comprises a poly(arylene ether) block and a polysiloxane block. The poly(arylene ether) block is a residue of the polymerization of the monohydric phenol. In some embodiments, the poly(arylene ether) block comprises arylene ether repeating units having the structure

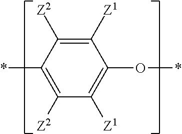

wherein for each repeating unit, each Z¹ is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each Z² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atom. In some embodiments, the poly(arylene ether) block comprises 2,6-dimethyl-1,4-phenylene ether repeating units, that is, repeating units having the structure

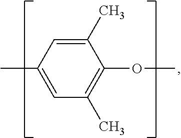

2,3,6-trimethyl-1,4-phenylene ether repeating units, or a combination thereof.

The polysiloxane block is a residue of the hydroxyaryl-terminated polysiloxane. In some embodiments, the polysiloxane block comprises repeating units having the structure

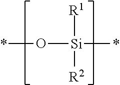

wherein each occurrence of R¹ and R² is independently hydrogen, C₁-C₁₂ hydrocarbyl or C₁-C₁₂ halohydrocarbyl; and the polysiloxane block further comprises a terminal unit having the structure

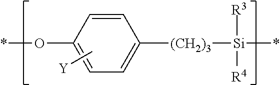

wherein Y is hydrogen, C₁-C₁₂ hydrocarbyl, C₁-C₁₂ hydrocarbyloxy, or halogen, and wherein each occurrence of R³ and R⁴ is independently hydrogen, C₁-C₁₂ hydrocarbyl or C₁-C₁₂ halohydrocarbyl. In some embodiments, the polysiloxane repeating units comprise dimethylsiloxane (—Si(CH₃)₂O—) units. In some embodiments, the polysiloxane block has the structure

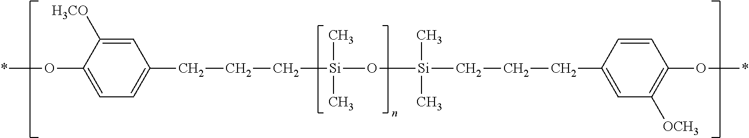

wherein n is 20 to 60.

The hydroxyaryl-terminated polysiloxane comprises at least one hydroxyaryl terminal group. In some embodiments, the hydroxyaryl-terminated polysiloxane has a single hydroxyaryl terminal group, in which case a poly(arylene ether)-polysiloxane diblock copolymer is formed. In other embodiments, the hydroxyaryl-terminated polysiloxane has two hydroxyaryl terminal groups, in which case in which case poly(arylene ether)-polysiloxane diblock copolymers and/or poly(arylene ether)-polysiloxane-poly(arylene ether) triblock copolymers are formed. It is also possible for the hydroxyaryl-terminated polysiloxane to have a branched structure that allows three or more hydroxyaryl terminal groups and the formation of corresponding branched copolymers.

The composition can, optionally, minimize or exclude polyamide. For example, in some embodiments, the composition comprises less than or equal to 5 weight percent polyamide, based on the total weight of the composition. Within this range, the composition can comprise less than or equal to 4 weight percent, specifically less than or equal to 3 weight percent, more specifically less than or equal to 2 weight percent, and still more specifically, less than or equal to 1 weight percent of polyamide, based on the total weight of the composition. In some embodiments, the composition excludes polyamide.

Polyamides, also known as nylons, are characterized by the presence of a plurality of amide (—C(O)NH—) groups and are described in U.S. Pat. No. 4,970,272 to Gallucci. Suitable polyamides include polyamide-6, polyamide-6,6, polyamide-4, polyamide-4,6, polyamide-12, polyamide-6,10, polyamide-6,9, polyamide-6,12, amorphous polyamides, polyamide-6/6T and polyamide-6,6/6T with triamine contents below 0.5 weight percent, polyamide-9T, and combinations thereof. In some embodiments, the polyamide comprises a polyamide-6,6. In some embodiments, the polyamide comprises a polyamide-6 and a polyamide-6,6. In some embodiments, the polyamide or combination of polyamides has a melting point (Tₘ) greater than or equal to 171° C.

The polyamide can have an intrinsic viscosity of up to 400 milliliters per gram (mL/g), specifically 90 to 350 mL/g, and more specifically 110 to 240 mL/g, as measured in a 0.5 weight percent solution in 96 weight percent sulfuric acid in accordance with ISO 307. The polyamide can have a relative viscosity of up to 6, specifically 1.89 to 5.43, and more specifically, a relative viscosity of 2.16 to 3.93. Relative viscosity is determined according to DIN 53727 in a 1 weight percent solution in 96 weight percent sulfuric acid.

The composition can, optionally, minimize or exclude carboxylic acids and carboxylic acid anhydrides. For example, in some embodiments, the composition comprises less than or equal to 2 weight percent combined of carboxylic acids and carboxylic acid anhydrides, based on the total weight of the composition. Within this range, the composition can comprise less than or equal to 1.5 weight percent, specifically less than or equal to 1 weight percent, and more specifically less than or equal to 0.5 weight percent combined, of carboxylic acids and carboxylic acid anhydrides, based on the total weight of the composition. In some embodiments, the composition excludes carboxylic acids and carboxylic acid anhydrides.

In this context, the terms “carboxylic acids” and “carboxylic acid anhydrides” refer to molecules, rather than to functional groups. Carboxylic acids include, for example, adipic acid, glutaric acid, malonic acid, succinic acid, phthalic acid, maleic acid, citraconic acid, itaconic acid, citric acid, hydrates of the foregoing acids, and a mixture thereof. Carboxylic acid anhydrides include, for example, adipic anhydride, glutaric anhydride, malonic anhydride, succinic anhydride, phthalic anhydride, maleic anhydride, citraconic anhydride, itaconic anhydride, and a mixture thereof. When the polyamide comprises a super tough polyamide, that is, a rubber-toughened polyamide, the composition may or may not contain a separate impact modifier. Polyamides can be obtained by a number of well-known processes such as those described in U.S. Pat. Nos. 2,071,250, 2,071,251, 2,130,523, and 2,130,948 to Carothers; 2,241,322 and 2,312,966 to Hanford; and 2,512,606 to Bolton et al. Polyamides are commercially available from a variety of sources.

In some embodiments the composition comprises less than or equal to 1 weight percent or electrically conductive fillers, based on the total weight of the composition. Electrically conductive fillers include, for example, carbon nanotubes, carbon fibers, electrically conductive carbon black, metal fibers, metal flakes, and a mixture thereof. In some embodiments, the composition excludes electrically conductive fillers.

In some embodiments, the composition consists essentially of 68 to 84 weight percent of a poly(phenylene ether); 6 to 16 weight percent of a hydrogenated block copolymer of an alkenyl aromatic compound and a conjugated diene, wherein the hydrogenated block copolymer comprises 10 to 45 weight percent poly(alkenyl aromatic) content, based on the weight of the hydrogenated block copolymer; 10 to 16 weight percent of a flame retardant consisting of an organophosphate ester; less than or equal to 2 weight percent combined of homopolystyrenes, rubber-modified impact polystyrenes, and unhydrogenated block copolymers of an alkenyl aromatic compound and a conjugated diene, based on the total weight of the composition; less than or equal to 4 weight percent polyolefin, based on the total weight of the composition; and less than or equal to 5 weight percent of a reinforcing filler having an average aspect ratio of greater than 3, based on the total weight of the composition; wherein the weight percents of the poly(phenylene ether), the hydrogenated block copolymer, and the flame retardant are based on the combined weight of the poly(phenylene ether), the hydrogenated block copolymer and the flame retardant.

In some embodiments, the composition comprises 72 to 79 weight percent of a poly(2,6-dimethyl-1,4-phenylene ether) having an intrinsic viscosity of 0.35 to 0.6 deciliters per gram, measured at 25° C. in chloroform; 9 to 13 weight percent of a polystyrene-poly(ethylene-butylene)-polystyrene triblock copolymer comprising 10 to 45 weight percent polystyrene content, based on the weight of the triblock copolymer, and having a weight average molecular weight of 100,000 to 400,000 atomic mass units; 12 to 15 weight percent of bisphenol A bis(diphenyl phosphate); less than or equal to 1 weight percent combined of homopolystyrenes, rubber-modified impact polystyrenes, and unhydrogenated block copolymers of an alkenyl aromatic compound and a conjugated diene, based on the total weight of the composition; less than or equal to 2 weight percent polyolefin, based on the total weight of the composition; and less than or equal to 1 weight percent of a reinforcing filler having an average aspect ratio of greater than 3, based on the total weight of the composition; wherein the weight percents of the poly(phenylene ether), the hydrogenated block copolymer, and the flame retardant are based on the combined weight of the poly(phenylene ether), the hydrogenated block copolymer and the flame retardant.

The composition has a combination of advantageous physical properties which make it ideally suited for use in photovoltaic junction boxes and connectors. The advantageous physical properties include high heat resistance, high impact strength, and high flame retardance. Specifically, the composition exhibits a notched Izod impact strength of at least 400 joules per meter, measured at 23° C. using a pendulum energy of 2.71 joules according to ASTM D 256-10; a heat deflection temperature of at least 115° C., measured at a sample thickness of 3.2 millimeters and a stress of 1.82 megapascals according to ASTM D 648-07; and a flame retardancy performance class of V-0 at a sample thickness of 1 millimeter, measured according to Underwriter's Laboratory Bulletin 94 “Tests for Flammability of Plastic Materials, UL 94”, 20 millimeter Vertical Burning Test, wherein the sample was conditioned at 23° C. and 50% relative humidity for a at least 48 hours prior to testing.

The invention extends to methods of preparing the composition. Thus, one embodiment is a method of forming a composition, comprising melt blending components comprising 68 to 84 weight percent of a poly(phenylene ether); 6 to 16 weight percent of a hydrogenated block copolymer of an alkenyl aromatic compound and a conjugated diene, wherein the hydrogenated block copolymer comprises 10 to 45 weight percent poly(alkenyl aromatic) content, based on the weight of the hydrogenated block copolymer; 10 to 16 weight percent of a flame retardant consisting of an organophosphate ester; less than or equal to 2 weight percent combined of homopolystyrenes, rubber-modified impact polystyrenes, and unhydrogenated block copolymers of an alkenyl aromatic compound and a conjugated diene, based on the total weight of the composition; less than or equal to 4 weight percent polyolefin, based on the total weight of the composition; and less than or equal to 5 weight percent of a reinforcing filler having an average aspect ratio of greater than 3, based on the total weight of the composition; wherein the weight percents of the poly(phenylene ether), the hydrogenated block copolymer, and the flame retardant are based on the combined weight of the poly(phenylene ether), the hydrogenated block copolymer and the flame retardant.

The melt blending can be performed using known equipment such as ribbon blenders, Henschel mixers, Banbury mixers, drum tumblers, single-screw extruders, twin-screw extruders, multi-screw extruders, co-kneaders, and the like. For example, the present composition can be prepared by melt-blending the components in a twin-screw extruder at a temperature of 250 to 350° C., specifically 260 to 290° C. The invention further extends compositions prepared by the method or obtainable by the method. All of the above-described variations in the composition apply as well to the method of preparing the composition.

The composition can be formed into articles by shaping, extruding, or molding. Articles can be molded from the composition by known methods, such as injection molding, injection compression molding, gas assist injection molding, rotary molding, blow molding, compression molding and related molding processes. In some embodiments, the article is formed by injection molding. The injection molding conditions can include a barrel temperature of 240 to 350° C., specifically 250 to 310° C., and a mold temperature of 50 to 100° C., specifically 60 to 90° C. Specific injection molding procedures applicable to the composition are described in the working examples below. All of the above-described variations in the composition apply as well to the injection molded article comprising the composition.

In some embodiments, the injection molded article comprises a composition comprising 68 to 84 weight percent of a poly(phenylene ether); 6 to 16 weight percent of a hydrogenated block copolymer of an alkenyl aromatic compound and a conjugated diene, wherein the hydrogenated block copolymer comprises 10 to 45 weight percent poly(alkenyl aromatic) content, based on the weight of the hydrogenated block copolymer; and 10 to 16 weight percent of a flame retardant consisting of an organophosphate ester; less than or equal to 2 weight percent combined of homopolystyrenes, rubber-modified impact polystyrenes, and unhydrogenated block copolymers of an alkenyl aromatic compound and a conjugated diene, based on the total weight of the composition; less than or equal to 4 weight percent polyolefin, based on the total weight of the composition; and less than or equal to 5 weight percent of a reinforcing filler having an average aspect ratio of greater than 3, based on the total weight of the composition; wherein the weight percents of the poly(phenylene ether), the hydrogenated block copolymer, and the flame retardant are based on the combined weight of the poly(phenylene ether), the hydrogenated block copolymer and the flame retardant.

In some embodiments, the injection molded article comprises a composition comprising: 72 to 79 weight percent of a poly(2,6-dimethyl-1,4-phenylene ether) having an intrinsic viscosity of 0.35 to 0.6 deciliters per gram, measured at 25° C. in chloroform; 9 to 13 weight percent of a polystyrene-poly(ethylene-butylene)-polystyrene triblock copolymer comprising 10 to 45 weight percent polystyrene content, based on the weight of the triblock copolymer, and having a weight average molecular weight of 100,000 to 400,000 atomic mass units; 12 to 15 weight percent of bisphenol A bis(diphenyl phosphate); less than or equal to 1 weight percent combined of homopolystyrenes, rubber-modified impact polystyrenes, and unhydrogenated block copolymers of an alkenyl aromatic compound and a conjugated diene, based on the total weight of the composition; less than or equal to 2 weight percent polyolefin, based on the total weight of the composition; and less than or equal to 1 weight percent of a reinforcing filler having an average aspect ratio of greater than 3, based on the total weight of the composition; wherein the weight percents of the poly(phenylene ether), the hydrogenated block copolymer, and the flame retardant are based on the combined weight of the poly(phenylene ether), the hydrogenated block copolymer and the flame retardant.

The composition is particularly well suited for molding photovoltaic junction boxes, connectors. Thus, in some embodiments, the injection molded article is as photovoltaic junction box, a photovoltaic connector, or a combination of a photovoltaic junction box and connector. Specific configurations for photovoltaic junction boxes and connectors are described in, for example, U.S. Pat. No. 7,291,036 to Daily et al.; U.S. Pat. No. 7,824,189 to Lauermann et al.; U.S. Patent Application Publication No. US 2010/0218797 A1 of Coyle et al.; and U.S. Patent Application Publication No. US 2010/0294903 A1 of Shmukler et al.

The invention includes at least the following embodiments.

### Embodiment 1

A composition comprising: 68 to 84 weight percent of a poly(phenylene ether); 6 to 16 weight percent of a hydrogenated block copolymer of an alkenyl aromatic compound and a conjugated diene, wherein the hydrogenated block copolymer comprises 10 to 45 weight percent poly(alkenyl aromatic) content, based on the weight of the hydrogenated block copolymer; 10 to 16 weight percent of a flame retardant consisting of an organophosphate ester; less than or equal to 2 weight percent combined of homopolystyrenes, rubber-modified impact polystyrenes, and unhydrogenated block copolymers of an alkenyl aromatic compound and a conjugated diene, based on the total weight of the composition; less than or equal to 4 weight percent polyolefin, based on the total weight of the composition; and less than or equal to 5 weight percent of a reinforcing filler having an average aspect ratio of greater than 3, based on the total weight of the composition; wherein the weight percents of the poly(phenylene ether), the hydrogenated block copolymer, and the flame retardant are based on the combined weight of the poly(phenylene ether), the hydrogenated block copolymer and the flame retardant.

### Embodiment 2

The composition of embodiment 1, wherein the hydrogenated block copolymer has a weight average molecular weight of at least 100,000 atomic mass units.

### Embodiment 3

The composition of any of the foregoing embodiments, wherein the composition exhibits a notched Izod impact strength of at least 400 joules per meter, measured at 23° C. using a pendulum energy of 2.71 joules according to ASTM D 256-10; a heat deflection temperature of at least 115° C., measured at a sample thickness of 3.2 millimeters and a stress of 1.82 megapascals according to ASTM D 648-07; and a flame retardancy performance class of V-0 at a sample thickness of 1 millimeter, measured according to Underwriter's Laboratory Bulletin 94 “Tests for Flammability of Plastic Materials, UL 94”, 20 millimeter Vertical Burning Test, wherein the sample was conditioned at 23° C. and 50% relative humidity for at least 48 hours prior to testing.

### Embodiment 4

The composition of any of the foregoing embodiments, wherein the organophosphate ester comprises: an organophosphate ester having the formula

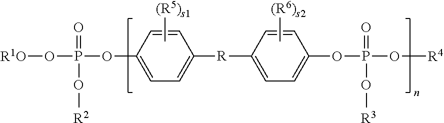

wherein R is independently at each occurrence a C₁-C₁₂ alkylene group; R⁵ and R⁶ are independently at each occurrence a C₁-C₅ alkyl group; R¹, R², and R⁴ are independently a C₁-C₁₂ hydrocarbyl group; R³ is independently at each occurrence a C₁-C₁₂ hydrocarbyl group; n is 1 to 25; and s1 and s2 are independently an integer equal to 0, 1, or 2; an organophosphate ester having the formula

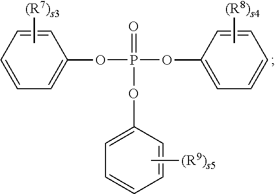

wherein R⁷, R⁸ and R⁹ are independently a C₁-C₁₂ hydrocarbyl group, and s3, s4 and s5 are independently an integer equal to 0, 1, 2, or 3; or a mixture thereof.

### Embodiment 5

The composition of any of the foregoing embodiments, wherein the organophosphate ester is selected from the group consisting of bisphenol A bis(diphenyl phosphate), resorcinol bis(diphenyl phosphate), and a mixture thereof.

### Embodiment 6

The composition of any of the foregoing embodiments, comprising less than or equal to 5 weight percent of a poly(phenylene ether)-polysiloxane block copolymer.

### Embodiment 7

The composition of any of the foregoing embodiments, comprising less than or equal to 5 weight percent polyamide, based on the total weight of the composition.

### Embodiment 8

The composition of any of the foregoing embodiments, comprising less than or equal to 2 weight percent combined of carboxylic acids and carboxylic acid anhydrides, based on the total weight of the composition.

### Embodiment 9

The composition of any of the foregoing embodiments, comprising less than 1 weight percent of the reinforcing filler, based on the total weight of the composition.

### Embodiment 10

The composition of any of the foregoing embodiments, wherein the hydrogenated block copolymer comprises a polystyrene-poly(ethylene-butylene)-polystyrene triblock copolymer having a weight average molecular weight of 100,000 to 400,000 atomic mass units.

### Embodiment 11

The composition of any of the foregoing embodiments, further comprising 0.02 to 0.25 weight percent of a polytetrafluoroethylene, based on the total weight of the composition.

### Embodiment 12

The composition of any of the foregoing embodiments, further comprising 1 to 5 weight percent tricalcium phosphate, based on the total weight of the composition.

### Embodiment 13

The composition of any of the foregoing embodiments, further comprising 0.1 to 5 weight percent titanium dioxide, based on the total weight of the composition.

### Embodiment 14

The composition of any of the foregoing embodiments, further comprising 0.5 to 5 weight percent of an ester of salicylic acid or anthranilic acid, based on the total weight of the composition.

### Embodiment 15

The composition of embodiment 1, wherein the composition comprises: 72 to 79 weight percent of the poly(phenylene ether), wherein the poly(phenylene ether) consists of poly(2,6-dimethyl-1,4-phenylene ether) having an intrinsic viscosity of 0.35 to 0.6 deciliters per gram, measured at 25° C. in chloroform; 9 to 13 weight percent of the hydrogenated block copolymer, wherein the hydrogenated block copolymer consists of a polystyrene-poly(ethylene-butylene)-polystyrene triblock copolymer comprising 10 to 45 weight percent polystyrene content, based on the weight of the triblock copolymer, and having a weight average molecular weight of 100,000 to 400,000 atomic mass units; 12 to 15 weight percent of the organophosphate ester, wherein the organophosphate ester consists of bisphenol A bis(diphenyl phosphate); less than or equal to 1 weight percent combined of the homopolystyrenes, rubber-modified impact polystyrenes, and unhydrogenated block copolymers of the alkenyl aromatic compound and the conjugated diene; less than or equal to 2 weight percent of the polyolefin; and less than or equal to 1 weight percent of the reinforcing filler having an average aspect ratio of greater than 3.

### Embodiment 15a

A composition comprising: 72 to 79 weight percent of a poly(2,6-dimethyl-1,4-phenylene ether) having an intrinsic viscosity of 0.35 to 0.6 deciliters per gram, measured at 25° C. in chloroform; 9 to 13 weight percent of a polystyrene-poly(ethylene-butylene)-polystyrene triblock copolymer comprising 10 to 45 weight percent polystyrene content, based on the weight of the triblock copolymer, and having a weight average molecular weight of 100,000 to 400,000 atomic mass units; 12 to 15 weight percent of bisphenol A bis(diphenyl phosphate); less than or equal to 1 weight percent combined of homopolystyrenes, rubber-modified impact polystyrenes, and unhydrogenated block copolymers of an alkenyl aromatic compound and a conjugated diene, based on the total weight of the composition; less than or equal to 2 weight percent polyolefin, based on the total weight of the composition; and less than or equal to 1 weight percent of a reinforcing filler having an average aspect ratio of greater than 3, based on the total weight of the composition; wherein the weight percents of the poly(phenylene ether), the hydrogenated block copolymer, and the flame retardant are based on the combined weight of the poly(phenylene ether), the hydrogenated block copolymer and the flame retardant.

### Embodiment 16

An injection molded article, comprising a composition comprising: 68 to 84 weight percent of a poly(phenylene ether); 6 to 16 weight percent of a hydrogenated block copolymer of an alkenyl aromatic compound and a conjugated diene, wherein the hydrogenated block copolymer comprises 10 to 45 weight percent poly(alkenyl aromatic) content, based on the weight of the hydrogenated block copolymer; and 10 to 16 weight percent of a flame retardant consisting of an organophosphate ester; less than or equal to 2 weight percent combined of homopolystyrenes, rubber-modified impact polystyrenes, and unhydrogenated block copolymers of an alkenyl aromatic compound and a conjugated diene, based on the total weight of the composition; less than or equal to 4 weight percent polyolefin, based on the total weight of the composition; and less than or equal to 5 weight percent of a reinforcing filler having an average aspect ratio of greater than 3, based on the total weight of the composition; wherein the weight percents of the poly(phenylene ether), the hydrogenated block copolymer, and the flame retardant are based on the combined weight of the poly(phenylene ether), the hydrogenated block copolymer and the flame retardant.

### Embodiment 17

The injection molded article of embodiment 16, wherein the hydrogenated block copolymer has a weight average molecular weight of at least 100,000 atomic mass units.

### Embodiment 18

The injection molded article of embodiment 16 or 17, wherein the organophosphate ester comprises: a bis(aryl) phosphate having the formula

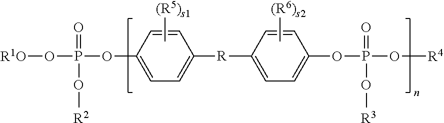

wherein R is independently at each occurrence a C₁-C₁₂ alkylene group; R⁵ and R⁶ are independently at each occurrence a C₁-C₅ alkyl group; R¹, R², and R⁴ are independently a C₁-C₁₂ hydrocarbyl group; R³ is independently at each occurrence a C₁-C₁₂ hydrocarbyl group; n is 1 to 25; and s1 and s2 are independently an integer equal to 0, 1, or 2; a tris(aryl) phosphate having the formula

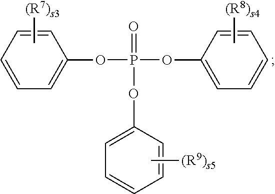

wherein R⁷, R⁸ and R⁹ are independently a C₁-C₁₂ hydrocarbyl group, and s3, s4 and s5 are independently an integer equal to 0, 1, 2, or 3; or a mixture thereof.

### Embodiment 19

The injection molded article of embodiment 16, wherein the composition comprises: 72 to 79 weight percent of the poly(phenylene ether), wherein the poly(phenylene ether) consists of poly(2,6-dimethyl-1,4-phenylene ether) having an intrinsic viscosity of 0.35 to 0.6 deciliters per gram, measured at 25° C. in chloroform; 9 to 13 weight percent of the poly(phenylene ether), wherein the poly(phenylene ether) consists of a polystyrene-poly(ethylene-butylene)-polystyrene triblock copolymer comprising 10 to 45 weight percent polystyrene content, based on the weight of the triblock copolymer, and having a weight average molecular weight of 100,000 to 400,000 atomic mass units; 12 to 15 weight percent of the organophosphate ester, wherein the organophosphate ester consists of bisphenol A bis(diphenyl phosphate); less than or equal to 1 weight percent combined of the homopolystyrenes, rubber-modified impact polystyrenes, and unhydrogenated block copolymers of the alkenyl aromatic compound and the conjugated diene; less than or equal to 2 weight percent of the polyolefin; and less than or equal to 1 weight percent of the reinforcing filler having an average aspect ratio of greater than 3.

### Embodiment 19a

An injection molded article comprising a composition comprising: 72 to 79 weight percent of a poly(2,6-dimethyl-1,4-phenylene ether) having an intrinsic viscosity of 0.35 to 0.6 deciliters per gram, measured at 25° C. in chloroform; 9 to 13 weight percent of a polystyrene-poly(ethylene-butylene)-polystyrene triblock copolymer comprising 10 to 45 weight percent polystyrene content, based on the weight of the triblock copolymer, and having a weight average molecular weight of 100,000 to 400,000 atomic mass units; 12 to 15 weight percent of bisphenol A bis(diphenyl phosphate); less than or equal to 1 weight percent combined of homopolystyrenes, rubber-modified impact polystyrenes, and unhydrogenated block copolymers of an alkenyl aromatic compound and a conjugated diene, based on the total weight of the composition; less than or equal to 2 weight percent polyolefin, based on the total weight of the composition; and less than or equal to 1 weight percent of a reinforcing filler having an average aspect ratio of greater than 3, based on the total weight of the composition; wherein the weight percents of the poly(phenylene ether), the hydrogenated block copolymer, and the flame retardant are based on the combined weight of the poly(phenylene ether), the hydrogenated block copolymer and the flame retardant.

### Embodiment 20

The injection molded article of any of embodiments 16 to 19a, wherein the injection molded article is a photovoltaic junction box, a photovoltaic connector, or a combination of a photovoltaic junction box and connector.

All ranges disclosed herein are inclusive of the endpoints, and the endpoints are independently combinable with each other. Each range disclosed herein constitutes a disclosure of any point or sub-range lying with the disclosed range.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another.

The invention is further illustrated by the following non-limiting examples.

### Example 1 and Comparative Examples 1-11

These examples illustrate the unexpected benefits of combining the specified components in the specified amounts to produce a molding composition that exhibits a surprisingly advantageous set of properties that make the molding composition especially suited for use in molding next generation photovoltaic junction boxes and connectors.

Components used to prepare the compositions are described in Table 1.

TABLE 1

| Component | Description |
|---|---|
| PPE 0.46 | Poly(2,6-dimethyl-1,4-phenylene ether), CAS Reg. No. 25134-01-4, |
| | having an intrinsic viscosity of 0.46 deciliter per gram measured in |
| | chloroform at 25° C.; obtained as PPO 646 from SABIC Innovative |
| | Plastics. |
| PPE 0.40 | Poly(2,6-dimethyl-1,4-phenylene ether), CAS Reg. No. 25134-01-4, |
| | having an intrinsic viscosity of 0.40 deciliter per gram measured in |
| | chloroform at 25° C., obtained as PPO 640 from SABIC Innovative |
| | Plastics. |
| Crystal PS | Atactic polystyrene in pellet form; CAS Reg. No. 9003-53-6, having a |
| | melt flow index of 4.8 grams per 10 minutes at 200° C. and a 5 kilogram |
| | load according to ASTM D1238, and a mineral oil content of less than 2 |
| | weight percent, obtained as EA3130 from Americas Styrenics. |
| Ground PS | Atactic polystyrene; CAS Reg. No. 9003-53-6, having a melt flow index |
| | of 1.5 grams per 10 minutes measured at 200° C. and a 5 kilogram load |
| | according to ASTM D1238, and a mineral oil content of less than 2 |
| | weight percent, obtained as 685DL from Americas Styrenics, and ground |
| | so that less than 10 weight percent is retained on a 12 mesh screen. |
| HIPS | High impact polystyrene; CAS Reg. No. 9003-55-8, having a volume |
| | average butadiene particle diameter of 2.4 micrometers, a rubber content |
| | of 10 weight percent, a swell index of 17, and a mineral oil content of 1.5 |
| | weight percent, obtained as GEH HIPS 1897 from SABIC Innovative |
| | Plastics. |
| SEBS | Polystyrene-poly(ethylene-butylene)-polystyrene triblock copolymer, |
| | CAS Reg. No. 66070-58-4, having a polystyrene content of 30-33 weight |
| | percent and a weight average molecular weight of 240,000-301,000, |
| | obtained as KRATON G1651 from Kraton Performance Polymers, Inc. |
| SBS | Polystyrene-polybutadiene-polystyrene triblock copolymer, CAS Reg. |
| | No. 9003-55-8, having a polystyrene content of 31%, obtained as |
| | KRATON D1101 from Kraton Performance Polymers, Inc. |
| LLDPE | Polyethylene, CAS Reg. No. 25087-34-7, having a density of 0.925 |
| | grams per cubic centimeter and a MVR of 20 cubic centimeters per 10 |
| | minutes at 190° C./2.16 kilograms, obtained as ESCORENE LL5100.09 |
| | from ExxonMobil. |
| AO-1 | Tris(2,4-di-tert-butylphenyl) phosphite, CAS Reg. No. 31570-04-4, |
| | obtained as IRGAFOS 168 from BASF Corp. |
| AO-2 | Tri(isodecyl) phosphite, CAS Reg. No. 25448-25-3, obtained as |
| | WESTON TDP from Chemtura. |
| AO-3 | 5 parts tri(nonyl phenyl) phosphate, CAS Reg. No. 26523-78-4 (TNPP) |
| | and 4 parts diphenyl isodecyl phosphite, CAS Reg. No. 26544-23-0 |
| | (DPDP). |
| AO-4 | Pentaerythritol tetrakis(3-laurylthiopropionate), CAS. Reg. No. |
| | 29598-76-3, obtained as SEENOX 412S from Haruno Sangyo Kaisha |
| | Ltd. |
| MgO | Magnesium oxide, CAS Reg. No. 1309-48-4, obtained as KYOWAMAG |
| | 150 from Kyowa Chemical Co. Ltd. |
| ZnO | Zinc oxide, CAS Reg. No. 1314-13-2, obtained as ZINKWEISS |
| | HARZSIEGEL CF from Norzinco GmbH. |
| ZnS | Zinc sulfide, CAS Reg. No. 1314-98-3, obtained as SACHTOLITH |
| | HD-S from Sachtleben Chemie GmbH. |
| C Black | Carbon black, CAS Reg. No. 1333-86-4, obtained as MONARCH M800 |
| | from Cabot. |
| TSAN | Poly(styrene-acrylonitrile)-encapsulated polytetrafluoroethylene; |
| | Poly(styrene-acrylonitrile) CAS Reg. No. 9003-54-7; |
| | polytetrafluoroethylene CAS Reg. No. 9002-84-0; obtained from SABIC |
| | Innovative Plastics. |
| BPADP | Bisphenol A bis(diphenyl phosphate), CAS Reg. No. 181028-79-5, |
| | obtained as NCendeX P30 from Albemarle. |
| RDP | Resorcinol diphosphate, CAS Reg. No. 57583-54-7, obtained as Reofos |
| | RDP from Chemtura. |

The compositions and properties of Example 1 and Comparative Examples 1-7 are summarized in Table 2, the compositions and properties of Example 2 and Comparative Examples 8-11 are summarized in Table 3, and the compositions and properties of Examples 2-7 are summarized in Table 4, where component amounts are in parts by weight. These compositions were prepared from the individual components as follows. The components were compounded in a 30 millimeter internal diameter Werner & Pfleiderer ZSK twin-screw extruder operating at 300 revolutions per minute and a throughput of 18.1 kilograms per hour (40 pounds per hour) or 20.4 kilograms per hour (45 pounds per hour). Feed, barrel and die temperatures are reported below. All components except for the organophosphate ester were added at the feed port of the extruder. The organophosphate ester (BPADP or RDP) was added via a liquid injector in the first half of the extruder, specifically in the second of ten extruder zones, just downstream of the feed port. The extrudate was pelletized by strand cutting, and the pellets were dried at 80° C. for four hours prior to subsequent use for injection molding.

The poly(phenylene ether) compositions were injection molded into articles for physical property testing. Flame bars were injection molded on an 80-Ton Van Dorn injection molding machine using a fan-gated tool for 1 millimeter thick flame bars and an end-gated tool for 2 millimeter thick flame bars. Parts for ASTM testing were molded on a 120-Ton Van Dorn injection molding machine using a family tool. Barrel and mold temperatures are reported below. Physical property values are reported in Tables 3-5. Heat deflection temperature (HDT) values, expressed in units of degrees centigrade, were measured at 264 pounds per square inch (1.82 megapascals) on 0.125 inch (3.2 millimeter) thick bars according to ASTM D648-07 and reported in Tables 3-5 rows labeled “HDT, 1.82 MPa, 3.2 mm (° C.)”. A heat deflection temperature of at least 115° C. is desirable for photovoltaic junction box and connector applications. Notched Izod impact strength values, expressed in units of joules per meter, were measured at 23, −30, and −40° C. using a 2 foot-pound-force (2.71 joule) hammer on 3.2 millimeter bars according to ASTM D256-10 and reported in Tables 3-5 rows labeled “Notched Izod Impact, 23° C. (J/m)”, “Notched Izod Impact, −30° C. (J/m)”, and “Notched Izod Impact, −40° C. (J/m)”, respectively. Bars for low-temperature impact testing were stored in a freezer at −30° C. or −40° C. for at least 24 hours prior to removal for immediate testing. A notched Izod impact strength at 23° C. of at least 400 joules per meter is desirable for photovoltaic junction box and connector applications. Multiaxial Impact Strength (MAI), expressed in joules (J), was measured at −40° C., at a sample thickness of 3.2 millimeters and with an impact velocity of 6.6 meters per second, in accordance with ASTM D 3763-06. The results are reported in Tables 3-5 rows labeled “MAI, Energy to Failure, 6.6 m/s, −40° C. (J)”.

Flame resistance was assessed by whether or not the test specimens achieved V-0 and 5VB ratings according to UL94—Standard for Tests for Flammability of Plastic Materials for Parts in Devices and Appliances, as specified in UL 1703—Flat Plate Photovoltaic Modules And Panels (Revised April 2008). The V-0 rating was determined according to the 20 Millimeter Vertical Burn test of UL94 using flame bars having a thickness of 1 millimeter, and the 5VB rating was determined according to the 125 Millimeter Horizontal Burn test of UL94 using flame bars having a thickness of 2 millimeters. The flame bars were conditioned at 23° C., 50% relative humidity for at least 48 hours prior to testing. The results are reported in Tables 3-5 rows labeled “UL V-0 at 1 mm^{a}” and UL 5VB at 2 mm^{a}”, with Y (Yes) or N (No) indicating whether the V-0 or 5VB rating was achieved or not. V-0 and 5VB ratings are desirable for photovoltaic junction box and connector applications.

The compositions and properties for Example 1 and Comparative Examples 1-7 are provided in Table 3. The compositions were compounded using a twin-screw extruder operating at 300 revolutions per minute and a throughput of 20.4 kilograms per hour (45 pounds per hour), a feed temperature of 250° C., a barrel temperature of 270° C., and a die temperature of 290° C. UL94 flame bars and ASTM test parts were injection molded using the barrel and mold temperatures in Table 2.

TABLE 2

| | Flame Bars | | ASTM Test Bars | |
|---|---|---|---|---|
| | Barrel Temp. | Mold Temp. | Barrel Temp. | Mold Temp. |
| Composition | ° F. (° C.) | ° F. (° C.) | ° F. (° C.) | ° F. (° C.) |
| Ex. 1 | 540-550 (282-288) | 185-190 (85-87.8) | 560 (293) | 190 (87.8) |
| C. Ex. 1, 6 | 520 (271) | 170 (76.7) | 500 (260) | 150 (65.6) |
| C. Ex. 2, 7 | 580 (304) | 190 (87.8) | 560 (293) | 190 (87.8) |
| C. Ex. 3-5 | 560 (293) | 190 (87.8) | 540 (282) | 190 (87.8) |

TABLE 3

| | C. Ex. | C. Ex. | C. Ex. | C. Ex. | C. Ex. | C. Ex. | C. Ex. |
|---|---|---|---|---|---|---|---|
| Ex. 1 | 1 | 2 | 3 | 4 | 5 | 6 | 7 |

COMPOSITIONS (PARTS BY WEIGHT)

| | | | | | | | | |
|---|---|---|---|---|---|---|---|---|
| PPE 0.46 | 73.95 | 50.42 | 84.2 | 70.04 | 66.95 | 64.4 | 0 | 81.2 |
| PPE 0.40 | 0 | 0 | 0 | 0 | 0 | 0 | 51.35 | 0 |
| SEBS | 12 | 0 | 5.6 | 5.73 | 0 | 0 | 0 | 6.2 |
| SBS | 0 | 2.44 | 0 | 0 | 0 | 0 | 3 | 0 |
| Ground PS | 0 | 0 | 0 | 0 | 0 | 0 | 0 | 2 |
| Crystal PS | 0 | 0 | 0 | 7.49 | 0 | 0 | 0 | 0 |
| HIPS | 0 | 28.49 | 0 | 0 | 18.66 | 22.63 | 22.9 | 0 |
| TSAN | 0.05 | 0.12 | 0 | 0.18 | 0 | 0 | 0.15 | 0 |
| LLDPE | 0 | 1.22 | 0.9 | 1.32 | 1.28 | 1.31 | 1 | 0 |
| MgO | 0 | 0 | 0.27 | 0.13 | 0.13 | 0.13 | 0.1 | 0 |
| ZnO | 0 | 0.12 | 0 | 0 | 0 | 0 | 0 | 0.15 |
| ZnS | 0 | 0.12 | 0.14 | 0.13 | 0.13 | 0.13 | 0.1 | 0.15 |
| AO-1 | 0 | 0 | 0 | 0.09 | 0.09 | 0.09 | 0.4 | 0 |
| AO-2 | 0 | 0.41 | 0 | 0 | 0 | 0 | 0 | 0 |
| AO-4 | 0 | 0 | 1.08 | 0 | 0 | 0 | 0 | 0 |
| AO-3 | 0 | 0 | 0 | 0 | 0 | 0 | 0 | 0.5 |
| BPADP | 14 | 0 | 0 | 14.89 | 12.76 | 11.31 | 21 | 0 |
| RDP | 0 | 16.7 | 7.9 | 0 | 0 | 0 | 0 | 9.8 |
| C Black | 0.5 | 0.5 | 0.5 | 0.5 | 0.5 | 0.5 | 0.5 | 0.5 |

PROPERTIES

| | | | | | | | | |
|---|---|---|---|---|---|---|---|---|
| Notched Izod | 556 | 261 | 299 | 267 | 117 | 143 | 158 | 364 |
| Impact, | | | | | | | | |
| 23° C. (J/m) | | | | | | | | |
| Notched Izod | 284 | 81 | 101 | 79 | 61 | 71 | 64 | 117 |
| Impact, | | | | | | | | |
| −30° C. (J/m) | | | | | | | | |
| Notched Izod | 183 | 80 | 85 | 63 | 55 | 68 | 64 | 83 |
| Impact, | | | | | | | | |
| −40° C. (J/m) | | | | | | | | |
| MAI, Energy to | 61 | 11 | 38 | 21 | 8 | 18 | 6 | 34 |
| Failure, 6.6 | | | | | | | | |
| m/s, −40° C. | | | | | | | | |
| HDT, 1.82 | 122 | 82 | 142 | 118 | 117 | 117 | 83 | 136 |
| MPa, 3.2 mm | | | | | | | | |
| (° C.) | | | | | | | | |
| UL V-0 | Y | Y | N | N | Y | Y | Y | Y |
| at 1 mm^{a} | | | | | | | | |
| UL 5VB | Y | N | Y | Y | Y | Y | N | Y |
| at 2 mm^{a} | | | | | | | | |

^{a}Minimum 5 bars conditioned at 23 ± 2° C., 50 ± 5% relative humidity for at least 48 hours.

For demanding end-use applications such as next generation photovoltaic junction boxes, molding compositions must have high heat resistance as measured by HDT, high impact strength as measured by notched Izod impact, and high flame retardance as indicated by UL94 V-0 and 5VB ratings. Specifically, it is desirable that the composition exhibits a notched Izod impact strength of at least 400 joules per meter, measured at 23° C. using a pendulum energy of 2.71 joules according to ASTM D 256-10; a heat deflection temperature of at least 115° C., measured at a sample thickness of 3.2 millimeters and a stress of 1.82 megapascals according to ASTM D 648-07; and a flame retardancy performance class of V-0 at a sample thickness of 1 millimeter. Based on the comparative examples in Table 3, it is evident that previous attempts to make a high HDT, UL V-0 at 1 millimeter, and/or high impact poly(phenylene ether)/polystyrene (PPE/PS) composition has come at the cost of adversely affecting at least one of these properties. The thermoplastic compositions of Comparative Examples 1-7 comprising PPE and PS, HIPS, or SBS do not meet the requirements for use in next generation photovoltaic junction boxes. It has unexpectedly been found that polystyrene-poly(ethylene-butylene)-polystyrene triblock copolymers (SEBS), such as Kraton G1651, can completely replace polystyrene, high impact polystyrene (HIPS), and/or polystyrene-polybutadiene-polystyrene triblock copolymer (SBS) in a poly(phenylene ether) composition which meets all the performance requirements. As can be seen from Table 2, even with HIPS contents of 19 to 28 weight percent (Comparative Examples 1 and 4-6), the target impact strength of at least 400 joules per meter at 23° C. was not achieved. However, an impact strength of 556 joules per meter at 23° C. was achieved with only 12 weight percent of SEBS in Example 1.

Most attempts to simultaneously achieve a high HDT, a UL V-0 rating at a thickness of 1 millimeter, and high impact strength have come at the cost of adversely affecting at least one of these properties. For instance, Comparative Examples 1 and 4-7 all had a UL V-0 rating at 1 millimeter, but the HDT values of Comparative Examples 1 and 6 were below 90° C., and the impact strengths of Comparative Examples 1 and 4-7 were below 400 joules per meter at 23° C. Comparative Examples 1-3 and 7 each had room temperature impact strength of over 200 joules per meter at 23° C., but Comparative Examples 2 and 3 failed to achieve a UL94 V-0 rating at a thickness of 1 millimeter, and Comparative Example 1 had an HDT value below 100° C. Comparative Examples 2-5 and 7 each had an HDT of at least 115° C., but Comparative Examples 2 and 3 failed to achieve a UL94 V-0 rating at a thickness of 1 millimeter and Examples 2-5 and 7 all had impact strengths below 400 joules per meter at 23° C. Comparative Examples 4, 5 and 7 had a UL V-0 rating at a thickness of 1 millimeters and an HDT of at least 115° C., but the impact strength was below 400 joules per meter at 23° C. These comparisons show that the weight percent of the components, as well as the type of components, affects the physical properties. Of all the compositions provided in Table 2, only Example 1, having an impact strength of 556 joules per meter, an HDT of 122° C., and a UL V-0 rating at a thickness of 1 millimeter, met or exceeded each of the critical-to-quality performance criteria for use in next generation photovoltaic junction boxes.

The compositions and properties for Example 2 and Comparative Examples 8-11 are provided in Table 4. The compositions were compounded using a twin-screw extruder operating at 300 revolutions per minute and a throughput of 18.1 kilograms per hour (40 pounds per hour), a feed temperature of 250° C., a barrel temperature of 280° C., and a die temperature of 300° C. UL94 flame bars and ASTM test parts for Comparative Examples 8-11 were injection molded using a barrel temperature of 550° F. (288° C.) and a mold temperature of 185° F. (85° C.).

TABLE 4

| | | | C. Ex. | C. Ex. |
|---|---|---|---|---|
| Ex. 2 | C. Ex. 8 | C. Ex. 9 | 10 | 11 |

COMPOSITIONS (PARTS BY WEIGHT)

| | | | | | |
|---|---|---|---|---|---|
| PPE 0.46 | 73.7 | 65.7 | 65.7 | 65.7 | 57.7 |
| SEBS | 12 | 12 | 16 | 20 | 20 |
| ZnS | 0.15 | 0.15 | 0.15 | 0.15 | 0.15 |
| MgO | 0.15 | 0.15 | 0.15 | 0.15 | 0.15 |
| BPADP | 14 | 22 | 18 | 14 | 22 |

PROPERTIES

| | | | | | |
|---|---|---|---|---|---|
| Notched Izod Impact, | 520 | 551 | 613 | 652 | 610 |
| 23° C. (J/m) | | | | | |
| Notched Izod Impact, | 238 | 209 | 334 | 472 | 406 |
| −30° C. (J/m) | | | | | |
| Notched Izod Impact, | 182 | 161 | 207 | 375 | 198 |
| −40° C. (J/m) | | | | | |
| MAI, Energy to Failure, | 48 | 38 | 55 | 57 | 20 |
| 6.6 m/s, −40° C. | | | | | |
| HDT, | 120 | 93 | 101 | 111 | 82 |
| 1.82 MPa, 3.2 mm (° C.) | | | | | |
| UL V-0 at 1 mm^{a} | Y | — | Y | — | Y |
| UL 5VB at 2 mm^{a} | Y | N | Y | Y | — |

^{a}Minimum 5 bars conditioned at room temperature.

Example 2 differs from Example 1 in that Example 2 has ZnS and MgO, but no carbon black, while Example 1 has carbon black, but not ZnS or MgO. Comparative Examples 8-11 each have high loadings of either BPADP (Comparative Examples 8, 9 and 11) or SEBS (Comparative Examples 10 and 11). The compositions having high loadings of BPADP (Comparative Examples 8, 9 and 11) all have reduced heat resistance, as measured by HDT. The compositions having high SEBS (Comparative Examples 10 and 11) also have reduced heat resistance. Although Comparative Example 11 has a high SEBS content (20 weight percent) and a UL94 rating of V-0, the V-0 rating was obtained using a high BPADP content (22 weight percent), which reduced the HDT to only 82° C.

Comparative Examples 8-11 show that increasing organophosphate ester content is associated with a substantial decrease in heat resistance, as measured by HDT. For instance, Comparative Examples 8 and 11, with BPADP contents of 22 weight percent, have HDT values of only 93 and 82° C., respectively. Comparative Examples 9-11 also show that increasing SEBS content improves impact strength, but is associated with reduced heat resistance and reduced flame retardance. Given these results, it was unexpected that a composition comprising both SEBS and organophosphate ester could simultaneously have high impact strength, high heat resistance, and high flame retardance. In particular, it was surprising that Example 2 had notched Izod impact strengths of 523 joules per meter at 23° C. and 238 joules per meter at −30° C., respectively, a HDT of 120° C., and a UL94 V-0 rating at a thickness of 1 millimeter. The composition of Example 2 unexpectedly strikes the right balance between organophosphate ester content and SEBS content to simultaneously achieve high heat resistance, impact strength and flame retardance for use in next generation photovoltaic junction boxes.

The compositions and properties for Examples 1 and 3-7 are provided in Table 5. The compositions were compounded using a twin-screw extruder operating at 300 revolutions per minute and a throughput of 20.4 kilograms per hour (45 pounds per hour), a feed temperature of 250° C., a barrel temperature of 270° C., and a die temperature of 290° C. UL94 flame bars were injection molded using a barrel temperature of 540-550° F. (282-288° C.) and a mold temperature of 185-190° F. (85-87.8° C.). ASTM test parts were injection molded using a barrel temperature of 560° F. (293° C.) and a mold temperature of 190° F. (87.8° C.). As can been seen from Table 5, each of Examples 1 and 3-7 had a notched Izod impact strength of at least 400 joules per meter, a HDT of at least 120° C., and a UL94 V-0 rating at a thickness of 1 millimeter.

TABLE 5

| | | | | | |
|---|---|---|---|---|---|
| Ex. 1 | Ex. 3 | Ex. 4 | Ex. 5 | Ex. 6 | Ex. 7 |

COMPOSITIONS (PARTS BY WEIGHT)

| | | | | | | |
|---|---|---|---|---|---|---|
| PPE 0.46 | 73.95 | 78.95 | 75.95 | 75.45 | 74.95 | 71.95 |
| SEBS | 12 | 9 | 9 | 11 | 13 | 13 |
| TSAN | 0.05 | 0.05 | 0.05 | 0.05 | 0.05 | 0.05 |
| BPADP | 14 | 12 | 15 | 13.5 | 12 | 15 |
| C Black | 0.5 | 0.5 | 0.5 | 0.5 | 0.5 | 0.5 |

PROPERTIES

| | | | | | | |
|---|---|---|---|---|---|---|
| Notched Izod | 556 | 488 | 478 | 545 | 611 | 580 |
| Impact, 23° C. | | | | | | |
| (J/m) | | | | | | |
| Notched Izod | 284 | 202 | 192 | 264 | 316 | 308 |
| Impact, −30° C. | | | | | | |
| (J/m) | | | | | | |
| Notched Izod | 183 | 135 | 126 | 176 | 225 | 208 |
| Impact, −40° C. | | | | | | |
| (J/m) | | | | | | |
| MAI, | 61 | 59 | 59 | 70 | 66 | 57 |
| Energy to Failure, | | | | | | |
| 6.6 m/s, −40° C. | | | | | | |
| (J) | | | | | | |
| HDT, 1.82 MPa, | 122 | 134 | 124 | 127 | 131 | 120 |
| 32 mm (° C.) | | | | | | |
| UL V-0 at 1 mm^{a} | Y | Y | Y | Y | Y | Y |
| UL 5VB at 2 mm^{a} | Y | Y | Y | Y | Y | Y |

^{a}Minimum 5 bars conditioned at 23 ± 2° C., 50 ± 5% relative humidity for at least 48 hours.

1-2. (canceled)

3. The composition of claim 15, wherein the composition exhibits:
a notched Izod impact strength of at least 400 joules per meter, measured at 23° C. using a pendulum energy of 2.71 joules according to ASTM D 256-10;
a heat deflection temperature of at least 115° C., measured at a sample thickness of 3.2 millimeters and a stress of 1.82 megapascals according to ASTM D 648-07; and
a flame retardancy performance class of V-0 at a sample thickness of 1 millimeter, measured according to Underwriter's Laboratory Bulletin 94 “Tests for Flammability of Plastic Materials, UL 94”, 20 millimeter Vertical Burning Test, wherein the sample was conditioned at 23° C. and 50% relative humidity for at least 48 hours prior to testing.

4-5. (canceled)

6. The composition of claim 15, comprising less than or equal to 5 weight percent of a poly(phenylene ether)-polysiloxane block copolymer.

7. The composition of claim 15, comprising less than or equal to 5 weight percent polyamide, based on the total weight of the composition.

8. The composition of claim 15, comprising less than or equal to 2 weight percent combined of carboxylic acids and carboxylic acid anhydrides, based on the total weight of the composition.

9-10. (canceled)

11. The composition of claim 15, further comprising 0.02 to 0.25 weight percent of a polytetrafluoroethylene, based on the total weight of the composition.

12. The composition of claim 15, further comprising 1 to 5 weight percent tricalcium phosphate, based on the total weight of the composition.

13. The composition of claim 15, further comprising 0.1 to 5 weight percent titanium dioxide, based on the total weight of the composition.

14. The composition of claim 15, further comprising 0.5 to 5 weight percent of an ester of salicylic acid or anthranilic acid, based on the total weight of the composition.

15. A composition comprising:
72 to 79 weight percent of a poly(2,6-dimethyl-1,4-phenylene ether) having an intrinsic viscosity of 0.35 to 0.6 deciliters per gram, measured at 25° C. in chloroform;
9 to 13 weight percent of a polystyrene-poly(ethylene-butylene)-polystyrene triblock copolymer comprising 10 to 45 weight percent polystyrene content, based on the weight of the triblock copolymer, and having a weight average molecular weight of 100,000 to 400,000 atomic mass units;
12 to 15 weight percent of bisphenol A bis(diphenyl phosphate);
less than or equal to 1 weight percent combined of homopolystyrenes, rubber-modified impact polystyrenes, and unhydrogenated block copolymers of an alkenyl aromatic compound and a conjugated diene, based on the total weight of the composition;
less than or equal to 2 weight percent polyolefin, based on the total weight of the composition; and
less than or equal to 1 weight percent of a reinforcing filler having an average aspect ratio of greater than 3, based on the total weight of the composition;
wherein the weight percents of the poly(2,6-dimethyl-4-phenylene ether), the polystyrene-poly(ethylene-butylene)-polystyrene triblock copolymer, and the bisphenol A bis(diphenyl phosphate) are each based on their combined weight.

16-18. (canceled)

19. An injection molded article comprising a composition comprising:
72 to 79 weight percent of a poly(2,6-dimethyl-1,4-phenylene ether) having an intrinsic viscosity of 0.35 to 0.6 deciliters per gram, measured at 25° C. in chloroform;
9 to 13 weight percent of a polystyrene-poly(ethylene-butylene)-polystyrene triblock copolymer comprising 10 to 45 weight percent polystyrene content, based on the weight of the triblock copolymer, and having a weight average molecular weight of 100,000 to 400,000 atomic mass units;
12 to 15 weight percent of bisphenol A bis(diphenyl phosphate);
less than or equal to 1 weight percent combined of homopolystyrenes, rubber-modified impact polystyrenes, and unhydrogenated block copolymers of an alkenyl aromatic compound and a conjugated diene, based on the total weight of the composition;
less than or equal to 2 weight percent polyolefin, based on the total weight of the composition; and
less than or equal to 1 weight percent of a reinforcing filler having an average aspect ratio of greater than 3, based on the total weight of the composition;
wherein the weight percents of the poly(2,6-dimethyl-4-phenylene ether), the polystyrene-poly(ethylene-butylene)-polystyrene triblock copolymer, and the bisphenol A bis(diphenyl phosphate) are each based on their combined weight.

20. The injection molded article of claim 19, wherein the injection molded article is a photovoltaic junction box, a photovoltaic connector, or a combination of a photovoltaic junction box and connector.
